(19) United States
(12) Patent Application Publication
(10) Pub. No.: US 2007/0096843 A1
(43) Pub. Date: May 3, 2007

(54) VARIABLE ATTENUATOR, HIGH FREQUENCY INTEGRATED CIRCUIT AND COMMUNICATION DEVICE

(75) Inventor: Koichi Mizuno, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/539,959

(22) Filed: Oct. 10, 2006

(30) Foreign Application Priority Data
Oct. 13, 2005 (JP) 2005/299338

(51) Int. Cl. H01P 1/22; H04B 3/04

(52) U.S. Cl. 333/17.1; 333/81 A

(57) ABSTRACT

The variable attenuator includes two transmission lines placed so as to be opposite to each other with space in between; a ground electrode which is grounded; a resistor which is connected to opposing ends of the two transmission lines as well as to the ground electrode; and a control electrode which adjoins to a part of the resistor between the opposing ends of the transmission lines and said ground electrode.

### BACKGROUND OF THE INVENTION

(1) Field of the Invention

The present invention relates to a wireless communication device which operates between the RF band and the microwave band, and in particular to a variable attenuator which controls a transmission amount of a high frequency signal.

(2) Description of the Related Art

In recent years and in many countries, various types of information communication devices such as cellular phones and portable terminals have been implemented using high frequency signals between the RF band and the microwave band as carrier signals. Accordingly, a variety of information communication services have been offered. As common technology for these various high frequency systems, there is technology which controls the signal level in each high-frequency circuit block. For instance, power control for an output block is used with the aim of preventing interference in another wireless system. Power control on the input side of an amplification element controls distortion levels of high-frequency signals and this kind of power control is utilized as a design means for ensuring communication quality. Additionally, power control is an important technology for stably operating high-frequency circuits by reducing unnecessary reflected power in antenna load fluctuations. Also, in a multistage amplifier, power control is utilized for achieving an amplification degree according to a predetermined value, or adjusting an input level of each amplification stage to a linear operation level.

As shown in FIG. 1, there is for instance a configuration for a signal attenuator that dynamically controls the amount of signal attenuation, the configuration including a Field Effect Transistor (FET) 13 for signal breaking and also a transmission line 14 for bypassing the signal, the Field Effect Transistor 13 and the transmission line 14 being placed between a transmission line 11 and a transmission line 12 (see for example, Patent Document 1, Japanese Laid-Open Patent Application No. 05-252016 Publication). Besides this, there are configurations in which resonant circuits are placed at both ends of a single transmission line, the resonant circuits being composed of resistance, capacity, and inductance elements (see for example, Patent Document 2, Japanese Laid-Open Patent Application No. 09-130107 Publication). There are also configurations in which a diode element is placed between the transmission line and the ground, utilizing plural transmission lines with different lengths (see for example, Patent Document 3, Japanese Laid-Open Patent Application No. 2000-252702 Publication). Moreover, there are configurations which provide the option to switch between a fixed attenuation circuit and a bypass circuit via a switch (see for example Patent Document 4, Japanese Laid-Open Patent Application No. 2002-261562 Publication). In addition, as shown in FIG. 2, a variable attenuator is also disclosed in which a resistance network called a π-shaped resistance network is composed of semiconductor resistances 31, 32 and 33, and a resistance value of the semiconductor resistances is changed by digital signals from an outside electrode by a variable attenuator (see for example, Patent Document 5, Japanese Laid-Open Patent Application No. 04-167601 Publication).

However, a high frequency circuit is generally configured given that a 50 Ω load is connected with an input terminal and an output terminal. With this configuration, it is possible to directly connect various kinds of high-frequency circuits without any impedance matching networks, and handling high-frequency circuit elements becomes simple. Variable attenuators are often configured in the same way as high frequency circuits, in that a 50Ω load is connected to the input/output terminal. The necessary attenuation value for a variable attenuator is determined according to system specifications and use. An optimum configuration for the variable attenuator is selected according to the attenuation value as well as the variable amount that are sought. A problem for the attenuating circuit is how to minimize additional noise and distortions added to the high frequency signal when the attenuating circuits are applied in a high frequency circuit. A simple configuration which operates with a single control voltage is preferable to a complicated configuration with plural control voltages; moreover, a simple configuration is also in demand for the circuit configuration itself.

In today's high-frequency circuit field, configuring an active element as a Microwave Monolithic Integrated Circuit (MMIC) has become mainstream. For configuring amplification elements in an MMIC configuration, a high-frequency circuit which has the functions necessary is configured by forming plural transistors and passive elements on a minute semiconductor substrate. However in the MMIC configuration, it is preferable to construct a variable attenuator on the same semiconductor substrate. For example, in a multistage amplifier, variable attenuators positioned inside an MMIC are in demand, the variable attenuators positioned with the aim of preventing excess input power to the following transistor, and of adjusting the amplification degree of the output amplification circuit itself. Thus, this variable attenuator must be able to be created at the same time as another semiconductor element formation process. Further, the MMIC is already sufficiently miniaturized in comparison with a hybrid circuit, known as a high-frequency module, in which individual parts have been placed on its ceramic or resin substrate. However, even with the MMIC, further miniaturization is required in order to bring down manufacturing costs. Therefore, a challenge is to achieve the variable attenuator with an even more miniature and simple configuration and construct the variable attenuator on a semiconductor substrate.

The disclosure of Japanese Patent Application No. 2005-299338 filed on Oct. 13, 2005 including specification, drawings and claims is incorporated herein by reference in its entirety.

### SUMMARY OF THE INVENTION

Further Information about Technical Background to this Application

The present invention has been conceived in view of the problems above, and has an object to provide a variable attenuator with a simple configuration capable of controlling attenuation from an outside signal and capable of being manufactured by a semiconductor process which produces MMICs. In particular, the present invention has an object of providing a structure for suppressing increases in noise and increases in distortion, resulting from inserting the variable attenuator into a high-frequency signal transmission, to a minimum. The present invention also has an object supplying a miniature wireless communication device with high-performance and outstanding stability which utilizes a variable amplification MMIC obtained by the structure above.

In order to accomplish the objects above, the variable attenuator in the present invention includes: two transmission lines placed so as to be opposite to each other with space in between; a ground electrode which is grounded; a resistor which is connected to opposing ends of the two transmission lines as well as to said ground electrode; and a control electrode which adjoins to a part of the resistor between the opposing ends of the transmission lines and the ground electrode.

Accordingly, a resistor is placed between the two transmission lines and further, by grounding a part of the resistor, the signal attenuation function can be realized. Further, a control electrode is connected to the resistor which is inserted between the two transmission lines and the ground electrode which touch the resistor, and a sheet resistance value for the resistor, placed near the control electrode, is controlled by the control signal, which is applied to the control electrode; as a result, signal attenuation between the two transmission lines can be controlled.

Note that the present invention is not only realized as a variable attenuator, but can also be realized as a high-frequency integrated circuit which includes the variable attenuator, a communication device which includes the high-frequency integrated circuit and so on.

Above and according to the present invention, a variable attenuator which controls high frequency power can be miniaturized by utilizing a semiconductor integrated circuit process for manufacturing MMICs. Also, since an MMIC can be manufactured with the semiconductor integrated circuit process, an MMIC can be formed on the same substrate. Thus, the effect is obtained whereby a miniature MMIC can be formed which modifies the signal amplification rate of an amplifier using an outside signal. In particular, when utilizing a semiconductor layer as a resistor, a semiconductor layer which composes a part of a transistor can be utilized and there is the effect that the manufacturing process can be simplified and the element configuration itself is simplified. Also, when metal silicide is used as a resistor, a variable attenuator with a large signal attenuation value can be configured, and further, an attenuation circuit can be configured whose characteristics are not modified much when the temperature changes. Also, by utilizing a control method that adjusts control voltage in multiple stages or utilizing plural control electrodes, the effect can be obtained in which the attenuation value can be controlled in multiple stages. Further, the effects of suppressing increased noise and distortion and realizing the variable attenuation function can be realized by a configuration which does not place electric conductors, such as control electrodes, against a resistor placed between transmission lines that serve as the input and output for a high-frequency signal.

By changing the attenuation value in a communication device which utilizes an MMIC with an integrated variable attenuator, it is possible to control transmission power. Further, a communication device configuration becomes possible for detecting a transferred and reflected signal and, according to its reflected power value, controlling the attenuation value for the variable attenuator that is inserted into the signal route. In other words, the output level of the amplifier itself is controlled by controlling the attenuation value of the variable attenuator against the load impedance change seen from the power amplifier, and as a result, the reflected power value inputted from the opposite direction of the amplifier output terminal can be reduced and the power amplification circuit can be protected from destruction. According to this structure, there are cases where it is possible to protect the transmission amplifier without using an isolator for a transmission power circuit, and the manufacturing cost for a transmission amplifier or a transmission device can be reduced. Or, by combining the transmission output circuit with an isolator, the reliability of transmission equipment operations can be increased.

Note that these variable attenuators show effects across a wide band, including frequency bands for wireless communication fields that are currently utilized and frequency bands planned to be used in the future, in other words, the frequency band from 10 MHz to 6 GHz, i.e. from the RF band to the microwave band. However, the present invention shows a remarkable effect in the above frequency band and further, from the sub millimeter wave band (up to 30 GHz) to the millimeter waveband (up to 75 GHz).

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a plane diagram which shows the configuration of a conventional variable attenuator;

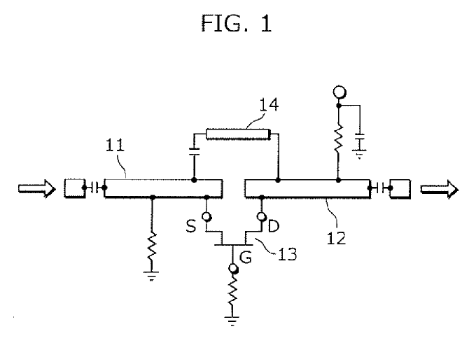

FIG. 2 is a plane diagram which shows the configuration of a conventional variable attenuator;

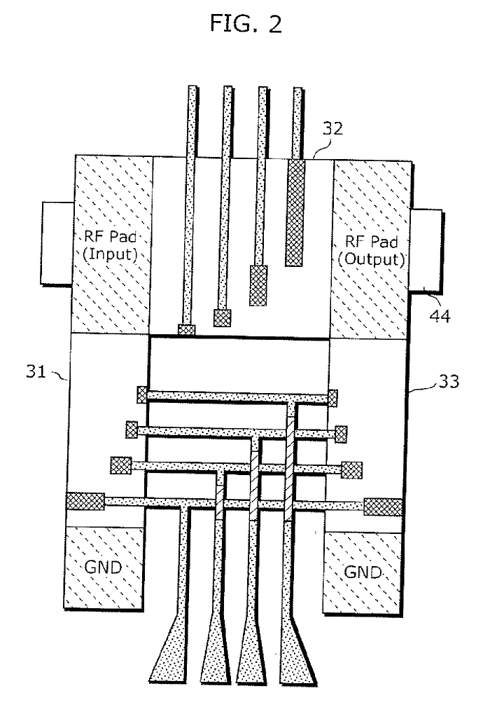

FIG. 3 is a plane diagram which shows the configuration of a variable attenuator in the first embodiment of the present invention;

FIG. 4 is a sectional view which shows a components section of the variable attenuator in the first embodiment of the present invention divided by a dividing line A-A;

FIG. 5 is a sectional view which shows a components section of the variable attenuator in the first embodiment of the present invention divided by a dividing line B-B;

FIG. 6 is a diagram which shows a typical distribution of a conduction carrier depletion layer in the vicinity of a control electrode in the first embodiment of the present invention;

FIG. 7 is a plane diagram which shows the configuration of a variable attenuator in the second embodiment of the present invention;

FIG. 8 is a diagram which shows the operation characteristics of a variable attenuator in the second embodiment of the present invention;

FIG. 9 is a diagram which shows a value relating to the operation characteristics of a variable attenuator in the second embodiment of the present invention;

FIG. 10 is a diagram which shows the variable attenuation of the variable attenuator in the second embodiment of the present invention;

FIG. 11 is a diagram which shows values related to the variable attenuation of the variable attenuator in the second embodiment of the present invention;

FIG. 12 is a plane diagram which shows the configuration of a variable attenuator in the third embodiment of the present invention;

FIG. 13 is a plane diagram which shows the configuration of a variable attenuator in the fourth embodiment of the present invention;

FIG. 14 is a plane diagram which shows the configuration of a variable attenuator in the fourth embodiment of the present invention;

FIG. 15 is a plane diagram which shows the configuration of a variable attenuator in the fifth embodiment of the present invention;

FIG. 16 is a sectional view which shows a component section of the variable attenuator in the fifth embodiment of the present invention divided by a dividing line C-C;

FIG. 17 is a plane diagram which shows the configuration of a variable attenuator in the sixth embodiment of the present invention;

FIG. 18 is a sectional view which shows a component section of a variable attenuator in the sixth embodiment of the present invention divided by a dividing line D-D;

FIG. 19 is a sectional view which shows a case where the resistors of the variable attenuator according to the present invention are formed by a deposited film;

FIG. 20 is a sectional view which shows a case where the resistors of the variable attenuator according to the present invention are formed by ion implantation;

FIG. 21 is a sectional view which shows a case where the resistors of the variable attenuator according to the present invention are formed by ion implantation;

FIG. 22 is a sectional view which shows a case where the control electrodes of the variable attenuator according to the present invention are formed using MOS;

FIG. 23 is a sectional view which shows a case where the variable attenuator according to the present invention has been resin-sealed;

FIG. 24 is a circuit block diagram which shows a first example of a high frequency wireless system which utilizes a variable attenuator according to the present invention;

FIG. 25 is a circuit block diagram which shows a second example of a high frequency wireless system that utilizes a variable attenuator according to the present invention;

FIG. 26 is a circuit block diagram which shows a third example of a high frequency wireless system which utilizes a variable attenuator according to the present invention; and

FIG. 27 is a circuit block diagram which shows a fourth example of a high frequency wireless system which utilizes a variable attenuator according to the present invention.

### DESCRIPTION OF THE PREFERRED EMBODIMENTS

### First Embodiment

Below, the first embodiment of the present invention is described in detail based on diagrams.

The variable attenuator according to the present embodiment includes two transmission lines placed so as to be opposite to each other with space in between, a ground electrode which is grounded, a resistor which is connected to the opposing ends of the two transmission lines as well as to the ground electrode, and a control electrode which adjoins to a part of the resistor between the opposing ends of the transmission lines and the ground electrode.

This variable attenuator may be positioned on a single substrate.

The variable attenuator in the present embodiment will be explained based on the elaborations above.

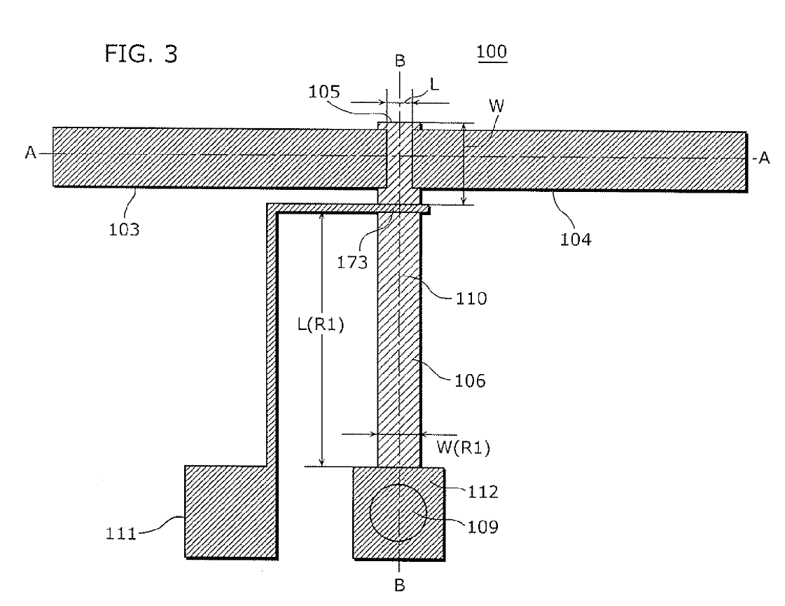

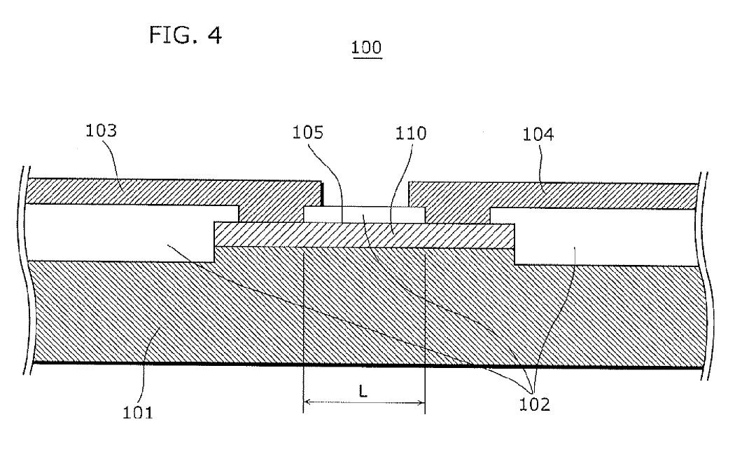

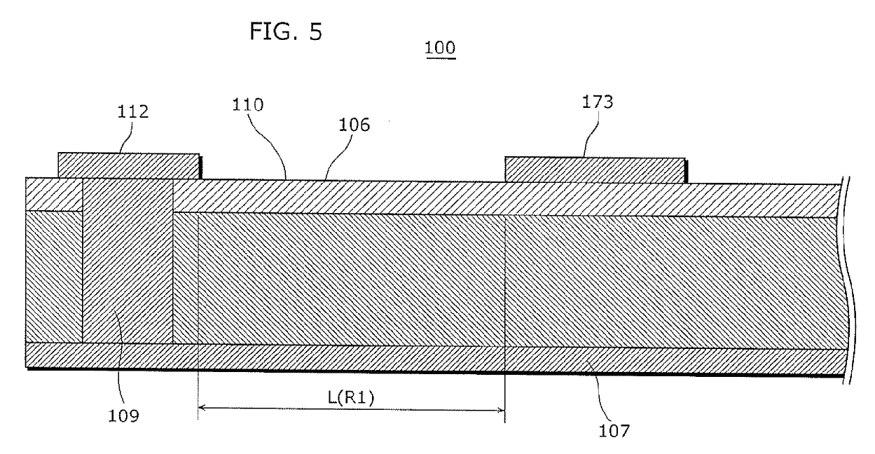

FIG. 3 is a plane diagram which shows the configuration of a variable attenuator in the present embodiment. FIG. 4 is a sectional view which shows a cross-section of components of the variable attenuator in the present embodiment divided by a dividing line A-A. FIG. 5 is a sectional view which shows a cross-section of components of the variable attenuator in the first embodiment of the present invention divided by a dividing line B-B.

As shown in FIG. 3 to FIG. 5, a resistor 110 is placed in the variable attenuator 100 and is composed of an inter-line resistance 105 and an inter-ground resistance 106; the resistor 110 is placed between a transmission line 103 and a transmission line 104 which are formed so as to sandwich an inter-layer dielectric film 102. In the resistor 110, a control electrode 173 is placed so that it is located between the inter-line resistance 105 and the ground electrode 112. The ground electrode 112 is grounded through a via hole 109 and an underside ground electrode 107, formed on the underside of the substrate 101.

The resistor 110 may also be formed by, for example, a semiconductor layer. To be more specific, the resistor 110 is composed of a semiconductor layer made of a channel layer of an electric field effect transistor, and a semiconductor layer formed as a base layer, an emitter layer and a collector layer of a bi-polar transistor. Here, the inter-line resistance 105 and the inter-ground resistance 106 are the same as the resistor 110. However, since the functions differ according to the position of the resistors, the resistors are used in clear distinction from each other.

In other words, in the resistor 110, the part located between the transmission line 103 and the transmission line 104 is called the inter-line resistance 105, and the part of the resistor 110 up to the ground electrode 112 and the control electrode 173 is called the inter-ground resistance 106. In the same way, inter-ground resistance refers hereafter to a part of the resistor adjoined to the ground electrode.

Note that a resistance value of the inter-line resistance 105 inserted between the transmission line 103 and the transmission line 104 is regulated by the resistivity and shape of the inter-line resistance 105 (width W, length L, and also thickness t). The resistance value of the inter-ground resistance 106, placed between the transmission lines and the ground, is regulated in the same way by the resistivity and the shape (W(R1), L(R1), and further, thickness t(R1)) of the interground resistance 106. Moreover, the value of the resistance placed between the transmission lines and the ground includes a resistance value added to a resistor of the control electrode.

Here, the transmission line 103 and the transmission line 104 are connected through a semiconductor resistance layer which is the resistor 110 formed on the substrate 101. The variable attenuator 100 is therefore a configuration for making a high-frequency signal transmit through the resistor 110 (the semiconductor resistance layer) and through the transmission line 103, the transmission line 104 and a ground.

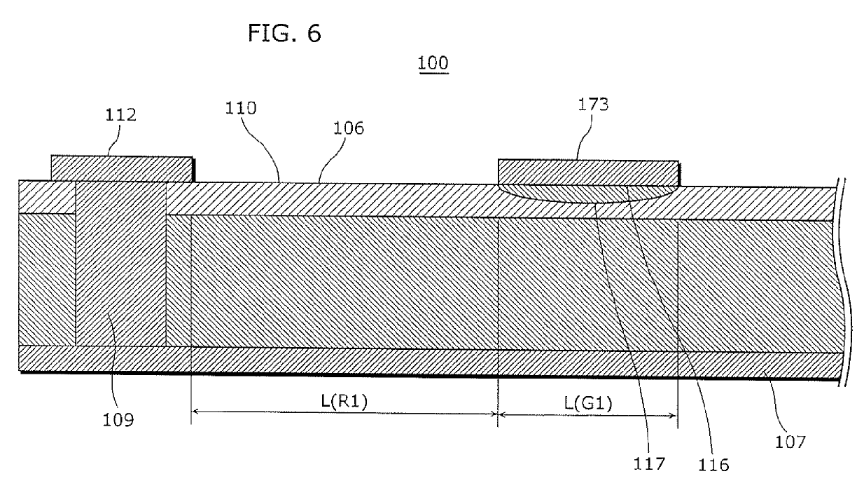

FIG. 6 is a schematic diagram which shows a typical distribution of a conduction carrier depletion layer in the vicinity of the control electrode in the first embodiment of the present invention. As shown in FIG. 6, a distribution for the depletion layer 117 is controlled by applying voltage through a Schottky barrier layer 116 which is formed between a control electrode 173 and the resistor 110; the control electrode 173 being placed on the resistor 110, and the depletion layer 117 being formed directly under the resistor 110 (the semiconductor resistance layer). As a result, the application of voltage through the Schottky barrier changes a sheet resistance value for the resistor 110 in the vicinity of the control electrode 173. Here, the resistor is made of resistance thin films which have a sheet resistance value of more than two types, and at least one type of film resistor may be made of semiconductor material. Among the film resistors, at least one type may be made of metal, an alloy made of several metals or an intermetallic compound.

More specifically, the control electrode 173 is composed of a metal electrode, or an alloy metal material, placed so that an electrical field will apply through the Schottky barrier or the insulation layer in the resistor 110 (the semiconductor resistance layer). Moreover, the depletion layer 117 is formed directly under and around the control electrode 173 by the application of voltage. The sheet resistance value of the resistor 110 (the semiconductor resistance layer) is changed by the distribution of the depletion layer 117 that is formed, as a result, the amount of signal attenuation between the transmission line 103 and the transmission line 104 is changed.

More specifically, the control electrode 173 changes the sheet resistance value of the resistor 110 utilizing an FET operation of a Field Effect Transistor (FET), which utilizes a Schottky electrode, or of a Metal Oxide Semiconductor (MOS).

For example, in an MMIC on a GaAs substrate, an epitaxial semiconductor layer which serves as a channel layer is used as the resistor 110, and by applying the voltage through the Schottky barrier formed between the metal electrodes, the depletion layer distribution of the semiconductor layer directly below is controlled, and as a result, the sheet resistor value of the resistor 110 in the vicinity of the control electrode 173 is changed. The basic idea is the same for a MOS configuration, which only differs in that the barrier layer is an Si oxide layer.

As above, the variable attenuator 100 in the present embodiment implements signal attenuation functions by situating the resistor 110 between the transmission line 103 and the transmission line 104, and further, by grounding a part of the resistor 110. Moreover, by connecting the resistor inserted between the transmission lines 103 and 104 and the ground, to the control electrode, the transmission lines 103 and 104 being adjacent to the resistor 110, and by controlling the sheet resistance value of the resistor 110 located near the control electrode 173 with a control signal applied to the control electrode, a configuration is provided for controlling the amount of signal attenuation between the transmission line 103 and the transmission line 104. Also, by setting a control voltage in multiple stages and utilizing plural control electrodes, the variable attenuator 100 is a configuration which can perform control on the value of attenuation step by step

### Second Embodiment

Next the second embodiment of the present invention will be described in detail based on diagrams. Note that the same reference numbers are attached and the descriptions not repeated for constituent elements identical to the constituent elements in the first embodiment.

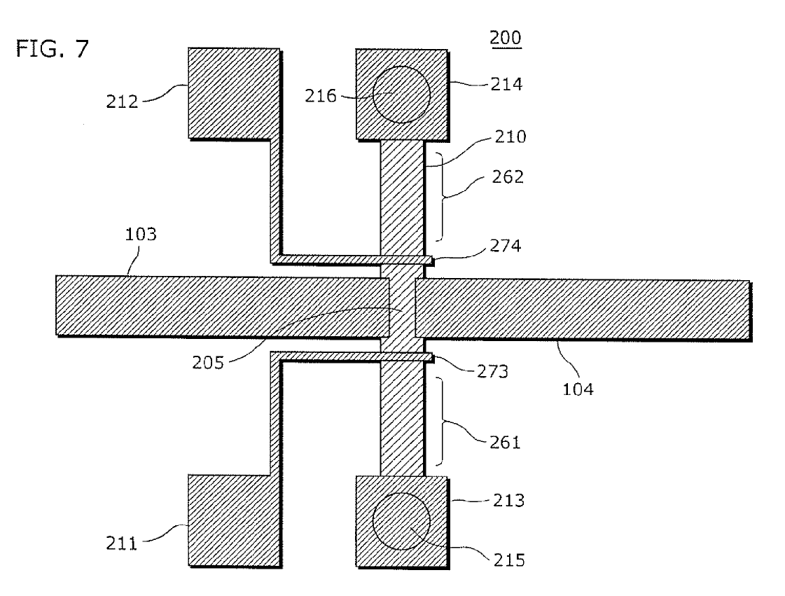

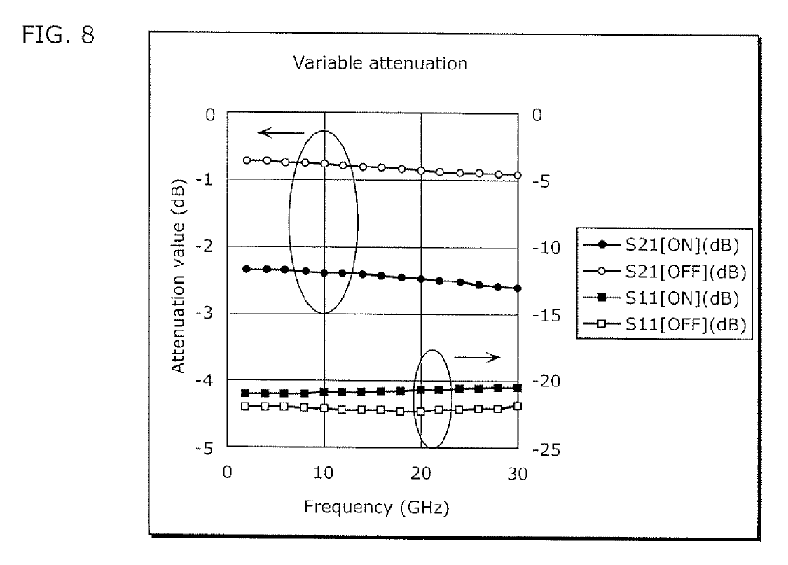

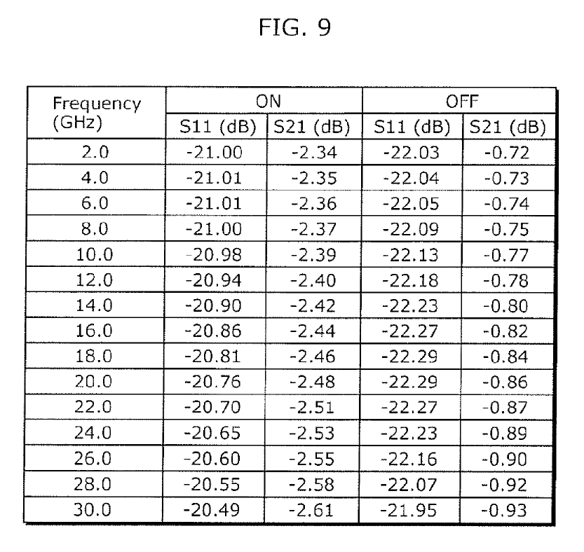

FIG. 7 is a plane diagram which shows the configuration of a variable attenuator in the present embodiment. FIG. 8 is a diagram which shows the operation characteristics of the variable attenuator. FIG. 9 is a diagram which shows a table in which this data has been gathered. As shown in FIG. 7, a semiconductor resistance layer controls a sheet resistance value by utilizing an epitaxial layer composed of a channel layer for a GaAs FET process, and by applying voltage, which is close to a threshold value for the voltage, to a control electrode 273.

As shown in FIG. 7, the variable attenuator 200 has a configuration which transmits a high-frequency signal through a resistor 210 (the semiconductor resistance layer). Here, the transmission line 103 and the transmission line 104 are connected through the semiconductor resistance layer, i.e. the resistor 210.

Note that, in comparison to the variable attenuator 100 (see for example, FIG. 3) in the first embodiment, the variable attenuator 200 has a symmetrical configuration for the transmission lines 103 and 104, and has the effect that the transmission properties of the high-frequency signals from the transmission lines 103 and 104 are nearly symmetrical. Moreover, since heat resistance decreases between the resistor 210 and the substrate, there is the effect that distortions in the high-frequency signal will not increase by much when the signal strength increases.

Also in the variable attenuator 200, the part located in the resistor 210 between the transmission line 103 and the transmission line 104 is an inter-line resistance 205. The section of the resistor 210 between a ground electrode 213 and a control electrode 273 is an inter-ground resistance 261. The section of the resistor 210 between a ground electrode 214 and a control electrode 274 is an inter-ground resistance 262.

As shown in FIG. 8 and FIG. 9, when the applied voltage is sufficiently larger than the threshold value voltage, this is called an ‘ON’ state and when the value is less than or equal to the threshold value voltage, this is called an ‘OFF’ state. Note that the area around the threshold value voltage has a specific value in an intermediate state between the ‘ON’ state and the ‘OFF’ state. At this point, as shown in FIG. 8 and FIG. 9, an attenuation value for the variable attenuator of at most approximately −2.5 dB, can be obtained in S21 (dB) and in the ON state. In the OFF state on the other hand, the attenuation value is approximately −0.7 dB. Subsequently, by setting the control voltage as the intermediate value, the attenuation value can be obtained as an arbitrary value between −0.7 dB and −2.5 dB.

Also, in S11 (dB), the value of the return-loss in both states is less than or equal to −20 dB, and a value of less than or equal to 1.22 is achieved for the voltage standing wave ratio. Further, the trend is flat up to 30 GHz and displays an extremely wide band variable attenuation in the millimeter waveband from about 10 MHz to the 30 GHZ. Here, an experiment is described for the variable attenuator in the present embodiment.

The variable attenuator 200 utilizes a substrate made of a semiconductor with a resistivity greater than or equal to 10 KΩ·cm.

Specifically, the variable attenuator 200 utilizes an FET (Field Effect Transistor) substrate (the resistivity of the substrate itself is from 10 KΩ·cm to 10 MΩ·cm) which utilizes GaAs materials, and the resistor 210 is used as the channel layer. The sheet resistance value of the channel layer is 34 (Ω/sq.) when there is no electric field application. The thickness of the GaAs substrate is 100 micron meters, and the back side of the substrate has an electrically grounded plane which is made of gold plating. The width of the transmission lines 103 and 104 is 80 micron meters, and a microstrip line with a characteristic impedance of approximately 50 Ω is composed by this configuration. The interval of the transmission lines 103 and 104 is 20 micron meters, in length and the inter-line resistance 205 is equivalent to a length of 20 micron meters and a width of 80 micron meters. The inter-ground resistance 261 and 262 have widths of 60 micron meters and lengths of 30 micron meters respectively. The interval between the transmission lines 103 and 104 and the inter-ground resistance 261 or the inter-ground resistance 262 is 10 micron meters and the so width of the interval is 20 micron meters. The control electrodes 273 and 274, which are 2 micron meters in width and made or WSi/Ti/Al/Ti or Ti/Al/Ti materials, are placed on the semiconductor resistance layer. When −2.4 V is applied to the control electrodes 273 and 274, the properties of the “OFF” state shown in FIG. 9 (5 GHz, attenuation value approximately −0.7 dB) are obtained. Further, when 0 V is applied to the control electrodes 273 and 274, the properties of the “ON” state (5 GHZ, attenuation value approximately −2.7 dB) are obtained, and it is confirmed that the return loss is less than or equal to −20 dB for both states.

Note that as another experiment, a substrate which includes Si as one of its constituent elements and is composed of a semiconductor with a resistivity of greater than or equal to 100 Ω·cm may be used. More specifically, when utilizing a CMOS circuit process for a high resistance Si substrate (a resistivity from 100 Ω·cm to 2 KΩ·cm) or even a poly-Si resistance layer as a resistor, the same kind of variable attenuator may be positioned. In particular, the above experiment shows that there is no effect on signal transmission properties when resin sealing with a resin with a permittivity of 3.5 as a sealer, and time variation of the signal transmission properties is suppressed to a small variation.

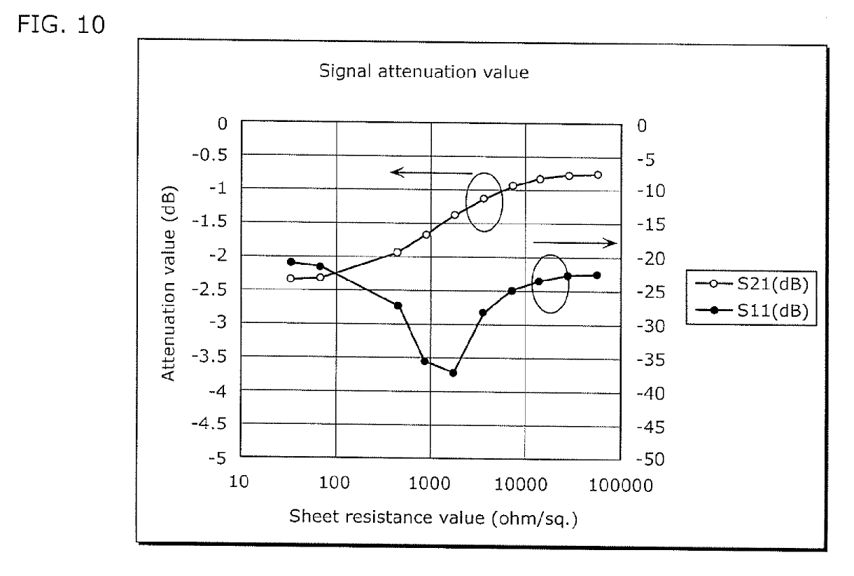

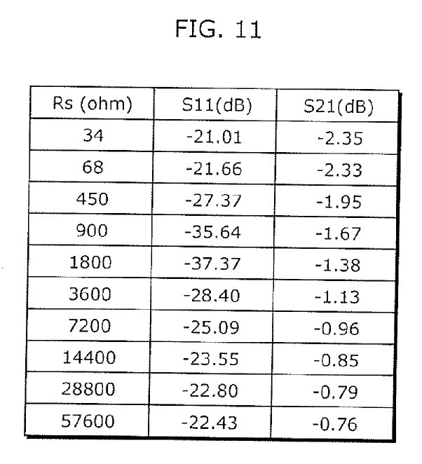

Note that above, the attenuation value is described such that it can be arbitrarily set, and a characteristic example of this attenuation value is shown in FIG. 10. A table in which attenuation values are summarized is also shown in FIG. 11. FIG. 10 and FIG. 11 show that the specific value expresses, for a frequency of 5 GHZ, the attenuation value between the transmission lines 103 and 104 relative to the sheet resistance under the control electrodes 273 and 274, as well as the return loss seen from the ends of the transmission lines. Along with changes in the sheet resistance value of the semiconductor resistance layer relative to the control voltage, the attenuation value for S21 (dB) changes from −2.35 dB to −0.76 dB. However, for S11 (dB), the return loss is less than −20 dB for this interval.

Above it is shown that the variable attenuator in the present embodiment displays a variable attenuation which may arbitrarily change a high-frequency signal attenuation value as well as set the return loss to less than or equal to −20 dB. Further, this variable attenuation can be achieved in the extremely wideband frequency range from the RF band to the millimeter waveband.

### Third Embodiment

Next, the third embodiment of the present invention will be described in detail based on diagrams. Note that the same reference numbers are attached and the descriptions not repeated for constituent elements identical to the constituent elements in the second embodiment.

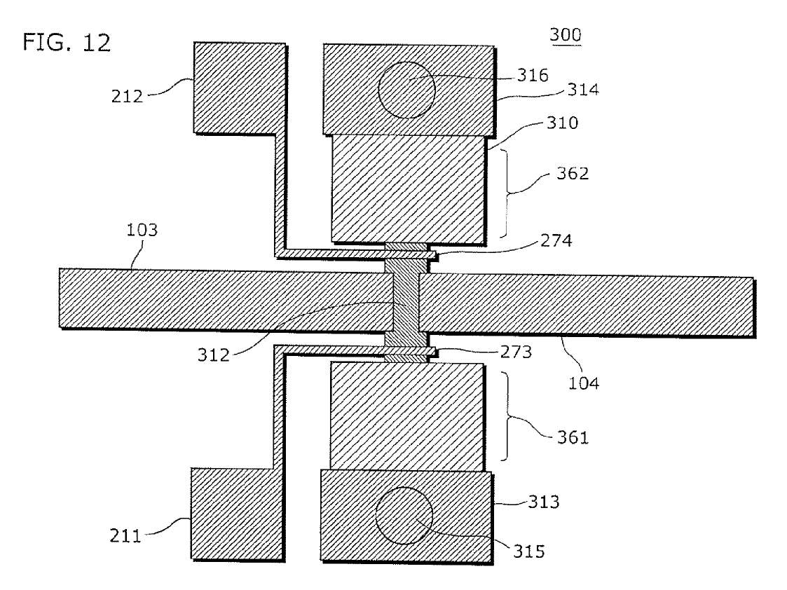

FIG. 12 is a plane diagram which shows the configuration of a variable attenuator in the present embodiment. As shown in FIG. 12, in comparison to the variable attenuator 200 (see for example, FIG. 7) in the second embodiment, an inter-ground resistance 361, an inter-ground resistance 362 and further, resistors 310 and 312 which construct the inter-line resistance, have a different shape (width of the shape) and a different sheet resistance value in the variable attenuator 300. This variable attenuator 300 is a more effective device; it optimally designs resistance values for each resistance in order to improve the attenuation (attenuation value) and the return loss.

Note that in order to increase the attenuation values which can be controlled, (1) the interval between the transmission line 103 and the transmission line 104 is expanded. Or (2), the width of the inter-line resistance is narrowed relative to the direction that the transmission lines 103 and 104 face. Or (3), resistance value can be increased by utilizing a large sheet resistance value for the inter-line resistance, and so on. The attenuation values can also be controlled by decreasing the inter-ground resistance value, further expanding the width of the inter-ground resistance, or, utilizing a small sheet resistance value, and so on.

At this point, there is an optimum value for the resistance values of the inter-line resistance and of the inter-ground resistances 361 and 362, which is a designed value, according to which the shape of the resistors is determined. Note that the inter-ground resistances 361 and 362, or the inter-line resistance are described as a semiconductor resistance layer. However, semiconductor materials are used for inter-ground resistances 361 and 362, the same variable attenuation function can be obtained with a metallic resistance layer or a metal silicide layer such as WSi for the inter-ground resistances 361 and 362. This is because the essential structures to obtain variable attenuation function in the present embodiment are introducing the semiconductor layer adjoined to the control electrodes 273 and 274.

### Fourth Embodiment

Next the fourth embodiment of the present invention will be described in detail based on diagrams. Note that the same reference numbers are attached and the descriptions not repeated for constituent elements identical to the constituent elements in the second embodiment.

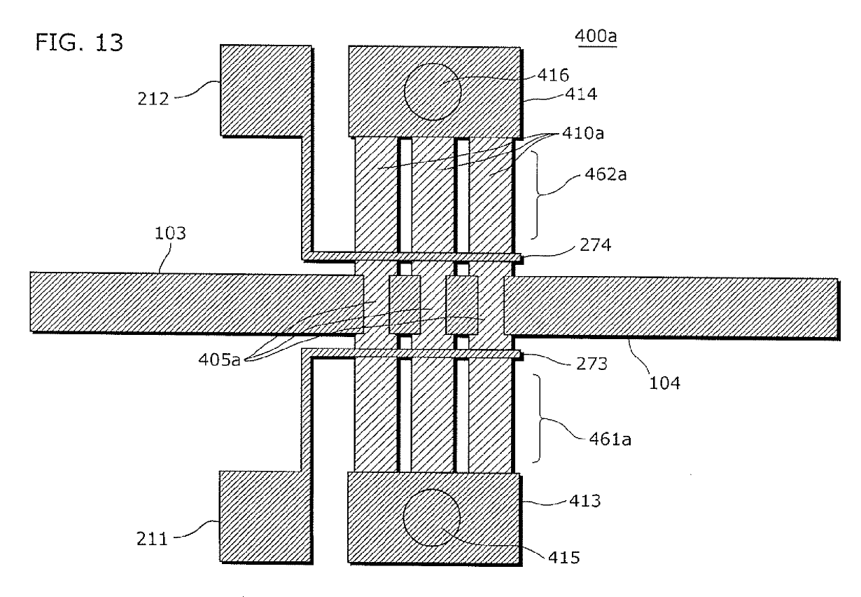

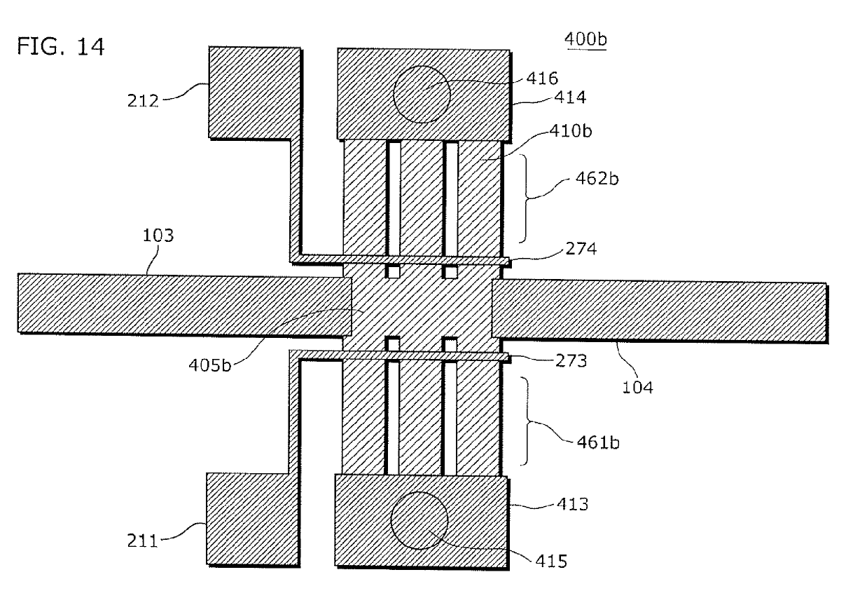

FIG. 13 is a plane diagram which shows the configuration of a variable attenuator in the present embodiment. As shown in FIG. 13, in comparison to the variable attenuator 200 (see for example, FIG. 7) in the second embodiment, a variable attenuator 400a utilizes plural semiconductor resistance layers 410a and has a configuration in which control electrodes 273 and 274 are shared. With this configuration, it is possible to increase the attenuation value relative to the variable attenuator 200 in the second embodiment. Also, by sharing the control electrodes 273 and 274, the control circuit configuration itself has the advantage of being easily constructed. Note that the inter-line resistance 405a between the transmission line 103 and the transmission line 104 is split into several resistances. However, as shown in FIG. 14, similar functions can be obtained with a single inter-line resistance 405b, as shown in FIG. 14.

### Fifth Embodiment

Next the fifth embodiment of the present invention will be described in detail based on diagrams. Note that the same reference numbers are attached and the descriptions not repeated for constituent elements identical to the constituent elements in the fourth embodiment.

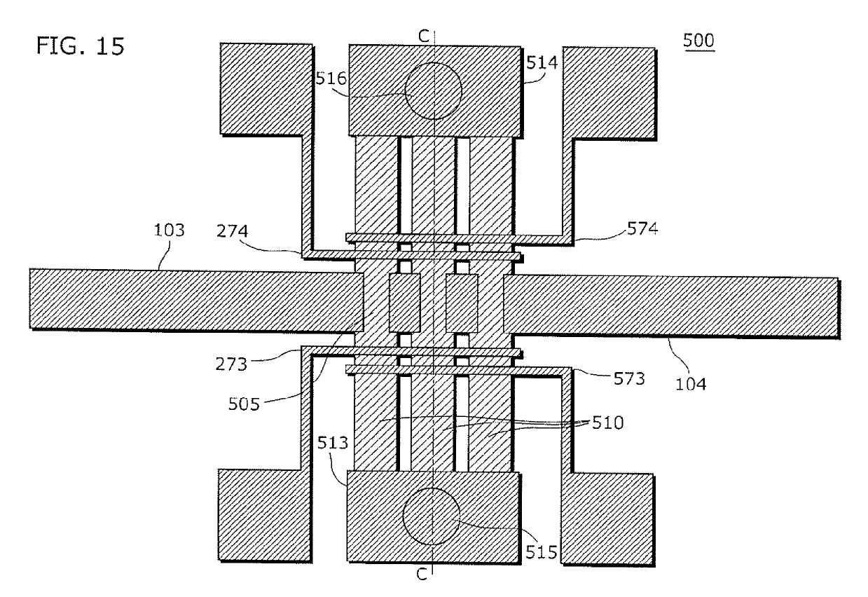

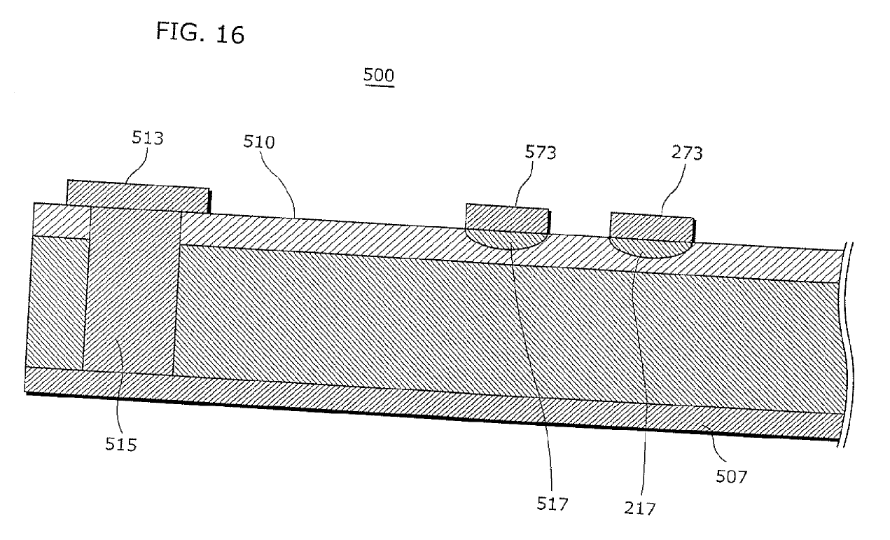

FIG. 15 is a plane diagram which shows the configuration of a variable attenuator in the present embodiment. As shown in FIG. 15, in comparison to the variable attenuator 400a (see for example, FIG. 13) in the fourth embodiment, a variable attenuator 500 is designed to include plural control electrodes. More specifically, in place of the control electrodes 273 and 274, the control electrodes 273 and 274 and the control electrodes 573 and 574 are included so that the resistance values between the lines and between the grounds can be controlled in a more flexible manner. More specifically, the voltage value applied to the control electrodes 273 and 274 is different from the voltage value applied to the control electrodes 573 and 574, and control of the attenuation value is performed by this combination of different voltages. Elements of a sectional view for the resistor, on which plural control electrodes are placed, are shown in FIG. 16. As shown in FIG. 16, for the variable attenuator 500, the shapes and volumes of the control electrodes 273, 274, 573, 574 are chosen appropriately according to use.

Note that in the present embodiment, since the control electrodes 273, 274, 573 and 574 are not placed between the high-frequency transmission lines 103 and 104, the component configuration becomes simplistic and has an advantage to reduce so additional high frequency noise from the control electrodes 273, 274, 573 and 574. Since there is no constriction on the physical dimensions of the high frequency signal path through all attenuation values, the non-linearity of the high-frequency signal power (harmonic level) is almost constant regardless of changes in the amount of signal attenuation. Since the resistivity of the semiconductor or the resistance layer in the present embodiment depends on the current density flowing through the materials, the non-linear characteristics of the high frequency signals are related to the current density of the signals in the transmission lines.

### Sixth Embodiment

Next the sixth embodiment of the present invention will be described in detail based on diagrams. Note that the same reference numbers are attached and the descriptions not repeated for constituent elements identical to the constituent elements in the first embodiment.

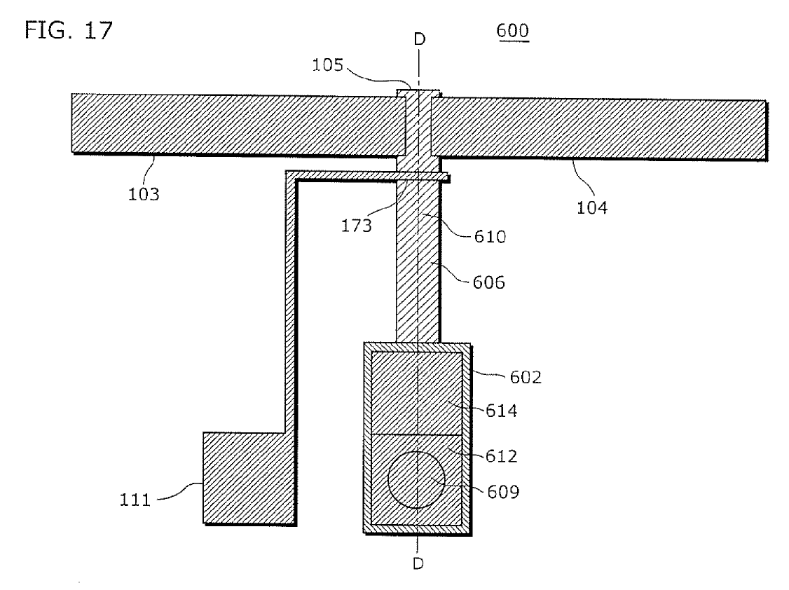

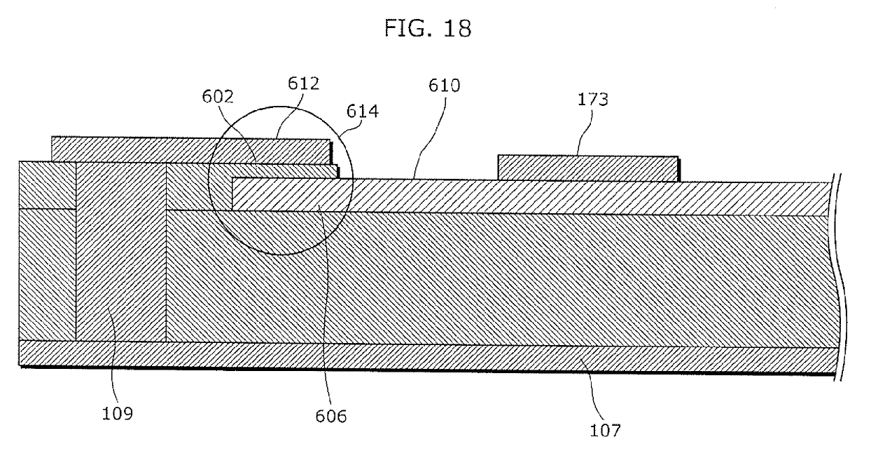

FIG. 17 is a plane diagram which shows the configuration of a variable attenuator in the present embodiment. FIG. 18 is a sectional view which shows the configuration of a variable attenuator in the present embodiment. As shown in FIG. 17 and FIG. 18, the variable attenuator 600 includes a capacitance element situated between a resistor and a ground electrode. More specifically, a metal insulator metal element (MIM) is inserted as a capacitance element 614 for stopping direct current, between an inter-ground resistance 606 and either a ground electrode 612 or a via hole 609. Note that in FIG. 17, an electrode for applying bias voltage to the ground resistance is omitted.

The capacitance element 614 is positioned by stacking the ground electrode 612 which sandwiches an inter-layer insulation film 602, on a ground resistance 606. A capacitance value is regulated by the film thickness, permittivity and moreover, dimensions of the stacked portions of the inter-layer insulation film 602. Since the resistor 610 can be biased to an arbitrary voltage, flexibility can be provided in the control method according to the voltage value given to the control electrode 173. For example, source voltage is applied to the control electrode 173 and by changing the electric potential for the inter-ground resistance 606; similar results can be obtained for the first through the fifth embodiments. It is possible to integrate the variable attenuator 600 in the present embodiment in an MMIC, which utilizes either a depletion or enhancement mode of an FET process.

Modification

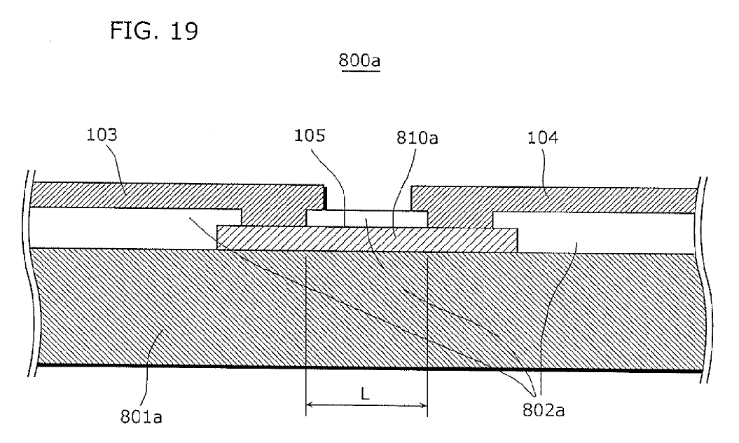

Note that, as shown in FIG. 19, a resistor 810a of a variable attenuator 800a in the present invention may be positioned by a film deposition. A film resistance pattern is formed by the lift-off method when a metal alloy resistor such as WSi is used in the film deposition. Subsequently, a resistor layer is formed in which the masking pattern for the lift-off is reflected.

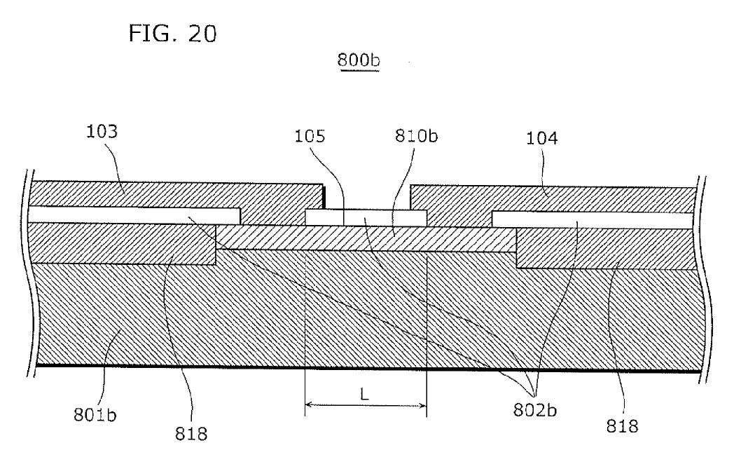

Note that, as shown in FIG. 20, the resistor 810b of the variable attenuator 800b in the present invention may utilize an epitaxial semiconductor layer which has been epitaxially grown on a semiconductor substrate 801b. Since an epitaxial semiconductor layer is normally formed over the entire surface on one side of the semiconductor substrate 801b, when an epitaxial semiconductor layer is used, parts used by the resistor are spared while unnecessary parts are removed using a chemical etching technique or a mechanical etching technique. Consequently, there are many instances in which the substrate 801b takes a mesa shape with one section dug in, as well as cases where the substrate 801b becomes a mesa configuration in which etching is stopped on the surface of an arbitrary layer among plural epitaxial layers.

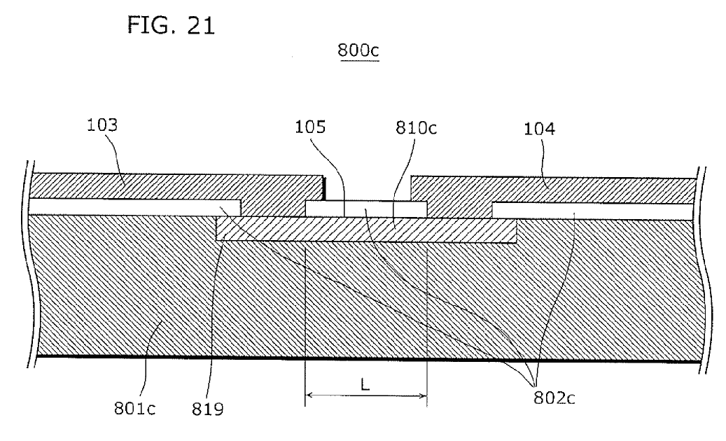

Note that as shown in FIG. 21, the resistor 810c of a variable attenuator 800c in the present invention may be formed by ion implantation. In this case, the resistivity of the substrate 801c is changed by ion implantation into the substrate and a resistance layer is formed. For ion implantation, the resistance can be diminished by performing ion implantation into parts which form a resistor layer 819 in the high-resistance substrate 801c, and the resistance can be increased when ion implantation is performed on parts other than the resistor 810c on the substrate 801c. In any case, the surface of the substrate generally has a flat configuration.

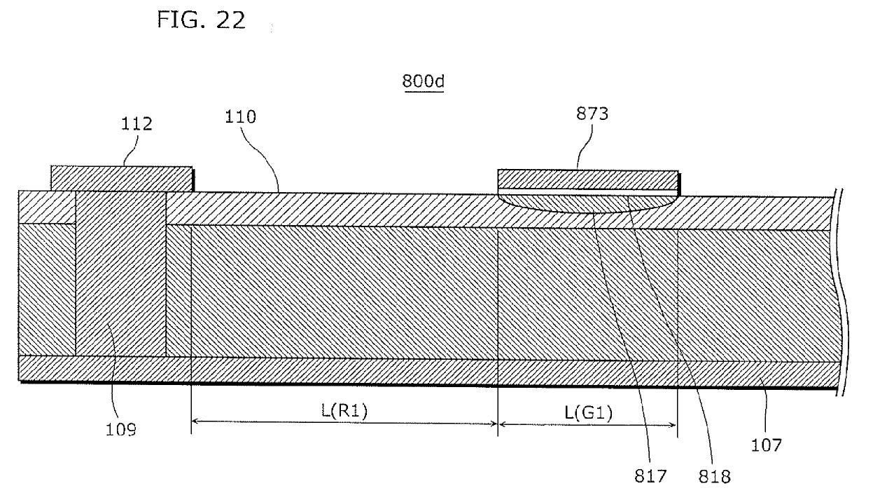

Note that as shown in FIG. 22, the parts configuration of a control electrode 873 may utilize a MOS transistor gate configuration instead of using metal and a Schottky barrier configuration in the semiconductive interface.

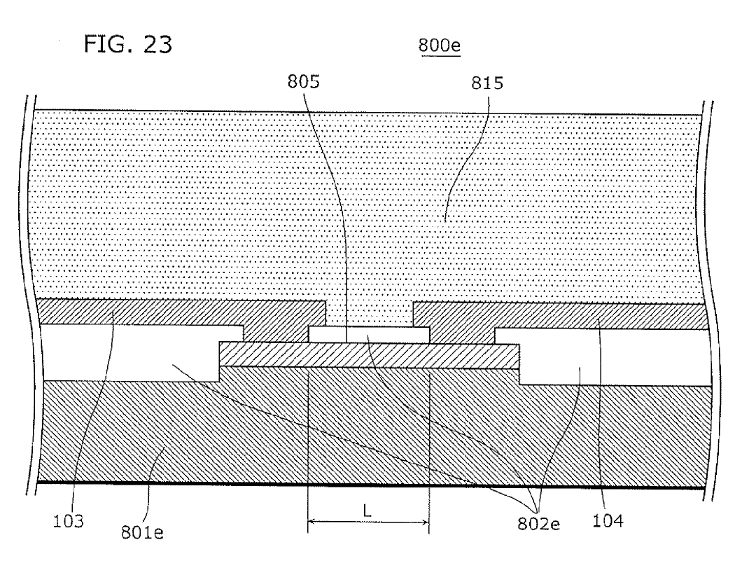

Note that as shown in FIG. 23, a variable attenuator 800e of the present invention may be resin-sealed. By resin-sealing the variable attenuator 800e, its moisture resistance, long-term reliability and so on can be guaranteed. Here, the substrate surface on which the two transmission lines are formed may be covered with resin-sealing with dielectric material that has a greater permittivity than the substrate material. With this, when a resin-sealing material 815 with a permittivity greater than the material of the substrate 801e is utilized, the effective wavelength of the high frequency signal in the transmission line, which includes an MMIC, directly decreases, and the MMIC, integrated into the variable attenuator, can itself be miniaturized. However, the substrate surface on which two of the transmission lines are positioned may be covered with a resin-sealing with dielectric material that has a permittivity lower than the substrate materials. With this, when a resin-sealing material 815 with a smaller permittivity than the substrate 801e material is used, a material with a smaller permittivity loss can be utilized and the signal transmission loss can be diminished. In particular, a remarkable effect is shown for MMICs which utilize Si substrates.

Note that a high-frequency circuit which includes the variable attenuator shown in the first through the sixth embodiments, as well as the transformation in the present invention, may be realized as a communication device in which an integrated circuit is positioned (below, called a high-frequency integrated circuit), a power detection circuit which detects power as a monitoring signal based on the high-frequency signal outputted from the high-frequency integrated circuit, and a control circuit which changes the control signal applied to the control electrode.

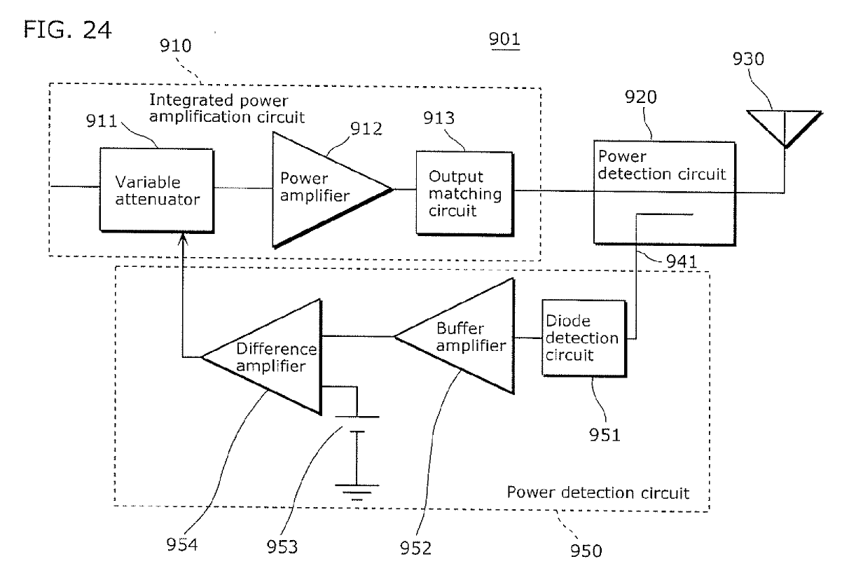

More specifically, as shown in FIG. 24, using a variable attenuator 911 in the present invention, a high-frequency wireless system 901 (i.e. a communications device) may be configured. In this case, an integrated power amplification circuit 910 (i.e. a high-frequency integrated circuit) includes an output matching circuit 913 composed of an FET formed on the GaAs substrate, a transmission line, a capacitance element and so on. Subsequently, the variable attenuator 911 is placed in the input stage of the integrated power amplification circuit 910. Further, control of all of the output power for the integrated power amplification circuit 910 is performed by the variable attenuator 911, which is placed in the step before a power amplifier 912.

Here, the variable attenuator 911 is one of the variable attenuators shown in the first through the sixth embodiments or the transformation of the present invention.

Also, a power detection circuit 920 detects transmitted power, and is situated between the integrated power amplification circuit 910 and an antenna 930 which is an interface circuit with the surrounding space.

Here a power detection circuit 950 (i.e. a control circuit) includes a diode detection circuit 951, and the output of the diode detection circuit 951 is amplified by the buffer amplifier 952.

Further, a differential amplifier 954 takes a difference between a reference voltage and voltage amplified by the buffer amplifier 952, the difference is inputted into a control electrode pad of the variable attenuator 911 after being amplified at an appropriate amplification degree in order to attune to a control signal input level at which ideal operations of the variable attenuator 911 are implemented. In other words, high-frequency transmission power control is carried out by modifying the value of the reference voltage to a desired value when high-frequency transmission power must be controlled according to the system operation requirements. Note that the power detection circuit 920 utilizes a directional coupler, and the like, having a degree of coupling which for the most part does not effect the signal path. Here this degree of coupling is −30 dB.

Also, the high-frequency wireless system 901 may be positioned on a single semiconductor substrate as an MMIC.

Note that the control circuit may be set to detect transmitted power and reflected power in the power detection circuit.

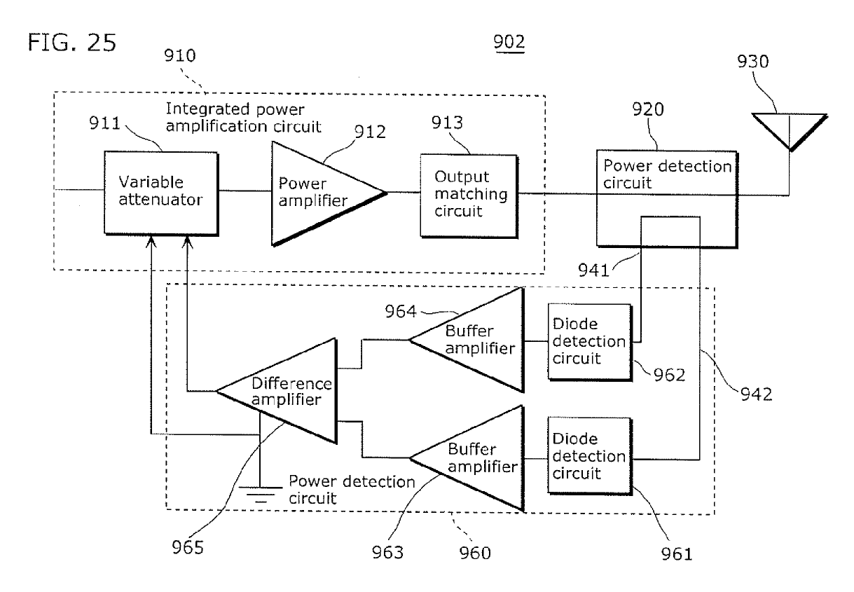

More specifically, as shown in FIG. 25, a high-frequency wireless system 902 (i.e. a communication device) may be configured using the variable attenuator 911 in the present invention. In this case, an electric power detection circuit 960 (i.e. a control circuit) changes the voltage for the transmitted power and reflection power in both diode detection circuits 961 and 962, and after amplifying the signals, obtained by the voltage changing, in buffer amplifiers 963 and 964, obtains a control signal according to the difference in a differential amplifier 965. This configuration in particular shows the effect of protecting the amplifiers against the impedance fluctuations. To give an outline of the high-frequency wireless system 902: in a normal usage state power reflection from the antenna 930 is, for the most part, not occurred, since the antenna 930 is used to be designed with impedances which satisfy conjugate matching conditions to the impedance of the surrounding space. On the other hand, when its load impedances have largely changed and, for example, when a conductive object or a dielectric substance approaches the vicinity of the antenna 930 while it is in use, high-frequency signal reflection occurs in part of the antenna 930 since there is impedance mismatching. When reflected power increases, it flows from the output terminal of the integrated power amplifier circuit 910 (i.e. a high-frequency integrated circuit) into, and in some cases destroys, the power amplifier 912. Here, when the reflected power grows, i.e. when the output of the differential amplifier 965 decreases, since the variable attenuator 911 is configured so that its attenuation value increases, the output electricity of the power amplifier 912 declines and the variable attenuator 911 operates effectively to reduce the amount of reflected power and perform functions to protect the power amplifier 912.

Note that the control circuit may be set to detect the phase difference of the transmitted power in the power detection circuit as well as the phase difference of the reflective power.

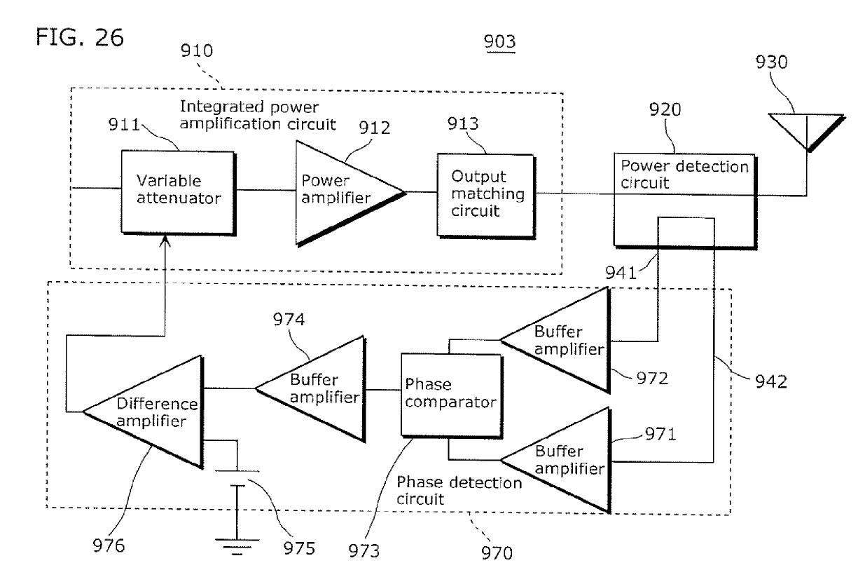

More specifically, as shown in FIG. 26, a high-frequency wireless system 903 may be configured using the variable attenuator 911 in the present invention. In this case, a phase difference detection circuit 970 (i.e. a control circuit) changes the output voltage according to the phase difference value between transmitting signal and reflecting signal, so as to control the variable attenuator circuit 911. This configuration also realizes a controlling operation according to the output impedance changes, in the same way as the configuration described in FIG. 25. By doing so, it is possible to realize the same effect, function and so on as when monitoring the power. This function is particularly effective in application to a device which needs to be protected against phase changes of output impedances.

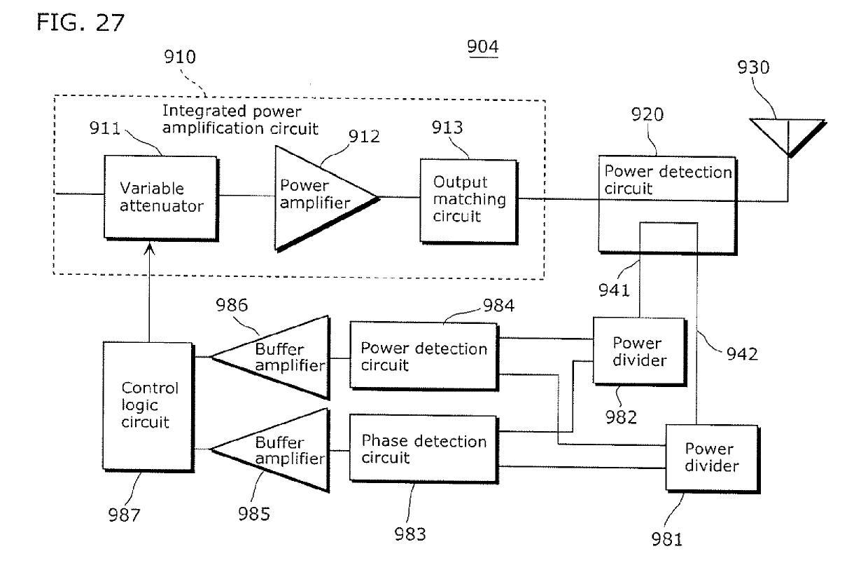

Note that as shown in FIG. 27, a high-frequency wireless system 904 may be configured using the variable attenuator 911 in the present invention. In this case, the high-frequency wireless system 904 monitors the power and the phase of output signals from power dividers 981 and 982 and obtains a load impedance by that value. A control signal level is computed in a control logic circuit 987 according to this load impedance. In this case, it is possible to control the level of input signals with the variable attenuator according to all of the possible ouput impedance conditions.

Note that the variable attenuator in the present invention may control a signal attenuation value for a high-frequency integrated circuit between the RF frequency band and the microwave band. As a result, the variable attenuator in the present invention is useful for performing amplification degree control for the amplification circuit and transmission power control for a power transmission circuit. In addition, if placed between the amplification circuits, the variable attenuator in the present invention demonstrates the effect of preventing excess power input to the following amplification circuit. In particular, the variable attenuator according to the present invention can be integrated as an MMIC and is useful in a high-frequency communication field such as one which uses miniature MMICs. Note that the present invention can be applied generally to a high-frequency field and is not limited to a high-frequency range (from 100 MHz to 30 GHz) which was shown as a frequency in the above experiment.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be utilized as a variable attenuator, and in particular, as a variable attenuator which may control the amount of signal attenuation in a high-frequency integrated circuit, and so on.

What is claimed is:

1. A variable attenuator comprising:
two transmission lines placed so as to be opposite to each other with space in between;
a ground electrode which is grounded;
a resistor which is connected to opposing ends of said two transmission lines as well as to said ground electrode; and
a control electrode which adjoins to a part of said resistor between the opposing ends of said transmission lines and said ground electrode.

2. The variable attenuator according to claim 1,
wherein said resistor is formed by a semiconductor layer.

3. The variable attenuator according to claim 1,
wherein said resistor is made of two types of film resistors having different sheet resistance values, and
at least one type of said film resistors is made of semiconductor material.

4. The variable attenuator according to claim 2,
wherein said resistor is made of two types of film resistors having sheet resistance values, and
at least one type of said film resistors is made of semiconductor material.

5. The variable attenuator according to claim 3,
wherein at least one type of said film resistors is made of one of metal, an alloy made of plural metals, and an intermetallic compound.

6. The variable attenuator according to claim 4,
wherein at least one type of said film resistors is made of one of metal, an alloy made of plural metals, and an intermetallic compound.

7. The variable attenuator according to claim 1, comprising
a plurality of said control electrodes.

8. The variable attenuator according to claim 2, comprising
a plurality of said control electrodes.

9. The variable attenuator according to claim 3, comprising
a plurality of said control electrodes.

10. The variable attenuator according to claim 4, comprising
a plurality of said control electrodes.

11. The variable attenuator according to claim 5, comprising
a plurality of said control electrodes.

12. The variable attenuator according to claim 6, comprising
a plurality of said control electrodes.

13. The variable attenuator according to claim 1, comprising
a capacitance element formed between said resistor and said grounded electrode.

14. The variable attenuator according to claim 2, comprising
a capacitance element formed between said resistor and said grounded electrode.

15. The variable attenuator according to claim 3, comprising
a capacitance element formed between said resistor and said grounded electrode.

16. The variable attenuator according to claim 4, comprising
a capacitance element formed between said resistor and said grounded electrode.

17. The variable attenuator according to claim 5, comprising
a capacitance element formed between said resistor and said grounded electrode.

18. The variable attenuator according to claim 6, comprising
a capacitance element formed between said resistor and said grounded electrode.

19. A high-frequency integrated circuit,
wherein said variable attenuator according to claim 1 is positioned on a single substrate.

20. The high-frequency integrated circuit according to claim 19,
wherein said substrate is made of semiconductor material.

21. The high-frequency integrated circuit according to claim 19,
wherein said substrate is made of a semi-insulating semiconductor with a resistivity of greater than or equal to 10 KΩ·cm.

22. The high-frequency integrated circuit according to claim 19,
wherein said substrate includes Si as a constituent element and is made of a semiconductor with a resistivity of greater than or equal to 100 KΩ·cm.

23. The high-frequency integrated circuit according to claim 19,
wherein a substrate surface, on which said two transmission lines are positioned, is covered with a dielectric material with a greater permittivity than the substrate material.

24. The high-frequency integrated circuit according to claim 19,
wherein a substrate surface, on which said two transmission lines are positioned, is covered with a dielectric material with a lower permittivity than the substrate material.

25. A communication device comprising:
a high-frequency circuit which includes the variable attenuator according to claim 1;
a power detection circuit which detects power as a detection signal based on a high-frequency signal outputted from the high-frequency integrated circuit according to claim 19; and
a control circuit which changes according to the detection signal detected in said power detection circuit, a control signal applied to the control electrode.

26. The communication device according to claim 25,
wherein said control circuit is operable to detect transmitted power and reflected power in said power detection circuit.

27. The communication device according to claim 25,
wherein said control circuit is operable to detect a phase difference between transmitted power and reflected power in said power detection circuit as well as a power difference between the transmitted power and the reflected power.
